(19) United States
(12) Patent Application Publication
(10) Pub. No.: US 2012/0158958 A1
(43) Pub. Date: Jun. 21, 2012

(54) IN-PLACE OBJECT MODEL ANALYSIS AND TRAVERSAL SYSTEM AND METHOD THEREOF

(76) Inventors: Jason P. Jeffords, Bedford, NH (US); Thomas M. Hazel, Andover, MA (US)

(21) Appl. No.: 13/327,923

(22) Filed: Dec. 16, 2011

Related U.S. Application Data
(60) Provisional application No. 61/424,294, filed on Dec. 17, 2010.

(51) Int. Cl. G06F 15/16

(52) U.S. Cl. 709/224

(57) ABSTRACT

A method, system, and computer program product for in-place object model analysis and traversal of third party objects/types in a cloud-based environment. Information is received from a third party system, including a plurality of third party objects and/or types. The information may pertain to both run-time structure and/or compile time structure. The received objects/types are analyzed at run-time without accessing the third party object model and/or source code. A re-usable meta schema is created and cached based on the analysis, including determining attributes, methods or supertypes for the objects/types. A type hierarchy may be pre-computed for the plurality of analyzed object models. The re-usable meta schema may then be used for run-time object/type traversal without accessing the third party object model/source code.

### CROSS-REFERENCE TO RELATED APPLICATION(S)

This application claims the benefit of U.S. Provisional Application No. 61/424,294 entitled “IN-PLACE OBJECT MODEL ANALYSIS AND TRAVERSAL SYSTEM AND METHOD THEREOF” filed on Dec. 17, 2010, which is expressly incorporated by reference herein in its entirety.

### BACKGROUND

1. Field

The present disclosure relates generally to communication systems, and more particularly, relates to the analysis and traversal of any object model at run-time in a cloud-based environment, without the need for access to the original object model or source code, although this information can be used if desired or available.

2. Background

The “cloud” is a next generation computing system that provides elasticity in using physical/virtual servers. A cloud-based environment includes computing resources, both physical and virtual servers, that can be dynamically and rapidly scaled and that are available via a network. Thus, a cloud-based environment includes the centralization of computing resources over a network. This enables systems to be built out in a horizontal manner, and enables services on demand. The cloud includes servers and back end databases that are accessible via access points such as web browsers at an access device.

Cloud computing software systems typically include multiple cloud components communicating with each other over application programming interfaces, such as web services. Cloud computing includes Web-based processing. Shared resources, software and information can be provided to computers and other access devices on demand via the Internet.

This provides a new delivery model for Information Technology (IT) services based on the Internet. Users can access web-based tools or applications via a web browser similar to the program being installed locally on their own computer.

Cloud computing architecture includes, e.g., a front end and a back end. The front end is seen by the client, i.e. the computer user. This front end includes the client's network (or computer) and the applications used to access the cloud via a user interface such as a web browser. The back end of the cloud computing architecture (e.g. the ‘cloud’ itself) includes computers, servers and data storage devices.

Cloud clients can include computer hardware and/or software that relies on cloud computing for application delivery or that is designed to deliver cloud services. This may include various access devices such as computers, phones, operating systems, browsers, and other devices.

Cloud computing provides agility, improving with users' ability to rapidly and inexpensively re-provision technological infrastructure resources; reduced costs; scalability; and device and location independence, by enabling users to access systems using a web browser regardless of their location or what device they are using (e.g., personal computer (PC) or mobile devices). As infrastructure is off-site (typically provided by a third-party) and accessed via the Internet, users can connect from anywhere. Cloud computing also enables resources to be shared across a large pool of users.

Applications may be run on a single server that includes a third party system and source code. To cloud enable this system and source code, without making any changes to the third party system, requires a virtualization of the application in the cloud. Each system includes its own basic model and corresponding object data.

Typically, knowledge of a third party's source code is necessary to provide run-time information for and add behavior to a running system. However, when building systems that run in a cloud environment, it would be beneficial to provide tool chains that are quick and easy to use and that will work in connection with existing run-time systems without modification or access to original source code.

### SUMMARY

In light of the above described problems and unmet needs, a system and method for analysis and traversal of object models is presented herein for third party systems. New state and behaviors can be added to existing systems at run-time without the need for access to the original object model or source code. This allows cloud-based tools and system enhancements to be provided without direct access to the third party source code and without making any changes to the third party system. This is done by creating a canonical meta object model, from run-time and/or static type/schema information, which is then utilized at run-time. The meta object model enables in-place object model analysis and traversal and the attachment/association of new state and behavior to existing objects and object models.

Aspects presented herein solve a large class of computing problems through object model analysis and traversal. For example, aspects of the present invention can address deep copy, serialization, transactions, transactional memory, and in-process and distributed garbage collection.

Aspects may include, for example, a method, system, and computer program product for performing in-place object model analysis for a third party system having third party source code, including receiving information from a third party system at run-time, the information including a plurality of items, each item comprising at least one selected from a group consisting of an object and a type; analyzing the received, third party items at run-time; creating a re-usable meta schema based on the analysis; and caching the re-usable meta-schema.

Additional aspects may include, for example, a method, system, and computer program product for performing in-place object model traversal for a third party system having a third party source code, including receiving an item, the item comprising an instance of at least one of an object and a type; accessing a cached meta schema, the meta schema comprising a plurality of handlers for objects and types; determining, via a processing device, whether the instance has previously been visited in the cached meta schema; determining whether an instance handler is registered for the item in the cached meta schema; and accessing the registered instance handler, after it is determined that the handler is registered for the item in the cached meta schema.

Additional advantages and novel features of these aspects of the invention will be set forth in part in the description that follows, and in part will become more apparent to those skilled in the art upon examination of the following or upon learning by practice of the invention.

### BRIEF DESCRIPTION OF THE DRAWINGS

Various aspects of the systems and methods will be described in detail, with reference to the following figures, wherein:

FIG. 1 illustrates an example aspect of a cloud computing system;

FIG. 2 presents an example system diagram of various hardware components and other features, for use in accordance with aspects of the present invention;

FIG. 3 is a block diagram of various example system components, in accordance with aspects of the present invention; and

FIGS. 4A-4D illustrates a flow chart of an example in-place object/type analysis in accordance with aspects of the present invention;

FIGS. 5A-5C illustrate a flow chart of aspects of in-place traversal, for use in accordance with aspects of the present invention;

FIG. 6 illustrates a flow chart with aspects of type handlers, for use in accordance with aspects of the present invention.

FIGS. 7-9 illustrate flow charts of an example method of in-place object model analysis, in accordance with aspects of the present invention.

### DETAILED DESCRIPTION

These and other features and advantages of this invention are described in, or are apparent from, the following detailed description of various example illustrations and implementations.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of systems capable of interacting in a cloud-based environment will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented using a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more example illustrations, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise random-access memory (RAM), read-only memory (ROM), Electrically Erasable Programmable ROM (EEPROM), compact disk (CD) ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

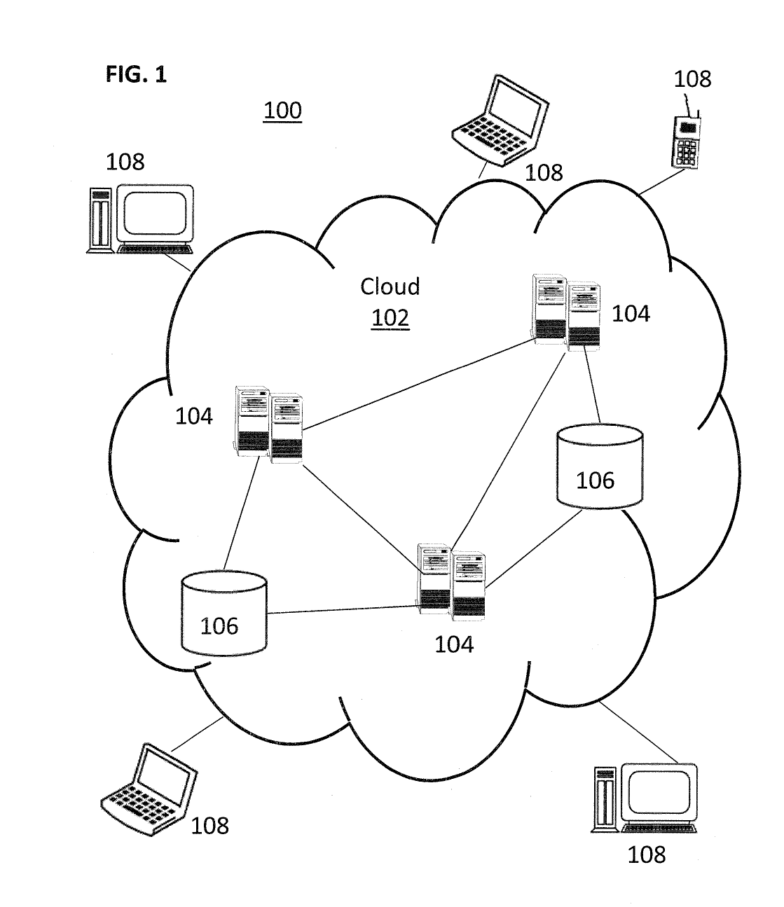

FIG. 1 illustrates aspects of a cloud based computing environment 100. The “cloud” 102 includes various servers 104 and databases 106 that provide services to various users 108 via a connection to the Internet.

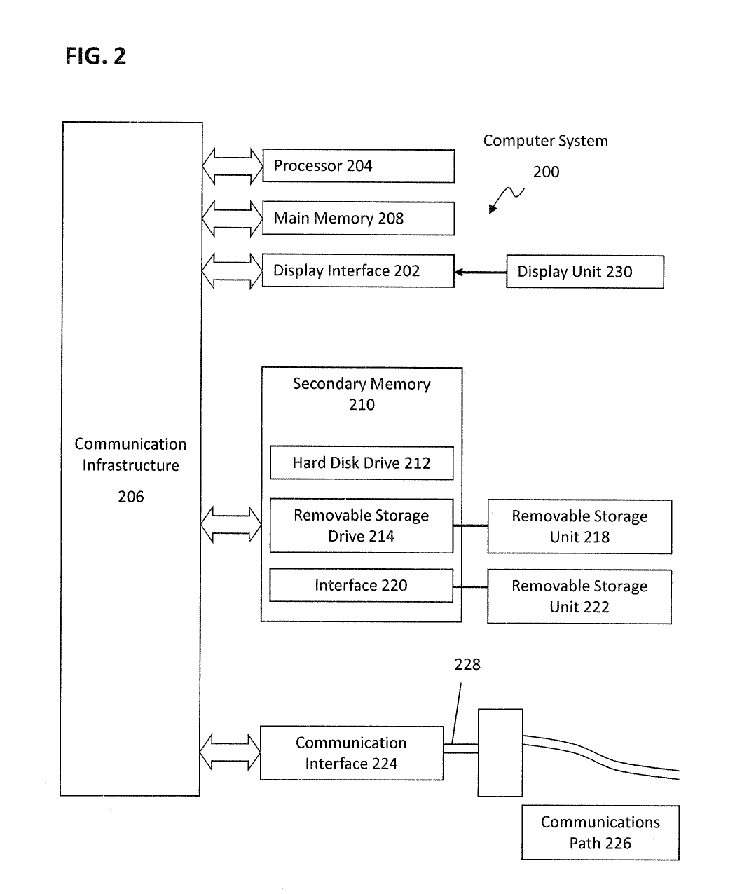

FIG. 2 presents an example system diagram of various hardware components and other features, for use in accordance with an implementation of the present invention. The present invention may be implemented using hardware, software, or a combination thereof and may be implemented in one or more computer systems or other processing systems. In one implementation, the invention is directed toward one or more computer systems capable of carrying out the functionality described herein. An example of such a computer system 200 is shown in FIG. 2.

Computer system 200 includes one or more processors, such as processor 204. The processor 204 is connected to a communication infrastructure 206 (e.g., a communications bus, cross-over bar, or network). Various software implementations are described in terms of this example computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on a display unit 230. Computer system 200 also includes a main memory 208, preferably RAM, and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative implementations, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an EPROM, or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 210 to perform the features of the present invention. Accordingly, such computer programs represent controllers of the computer system 200.

In an implementation where the invention is implemented using software, the software may be stored in a computer program product and loaded into computer system 200 using removable storage drive 214, hard drive 212, or communications interface 220. The control logic (software), when executed by the processor 204, causes the processor 204 to perform the functions of the invention as described herein. In another implementation, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another implementation, the invention is implemented using a combination of both hardware and software.

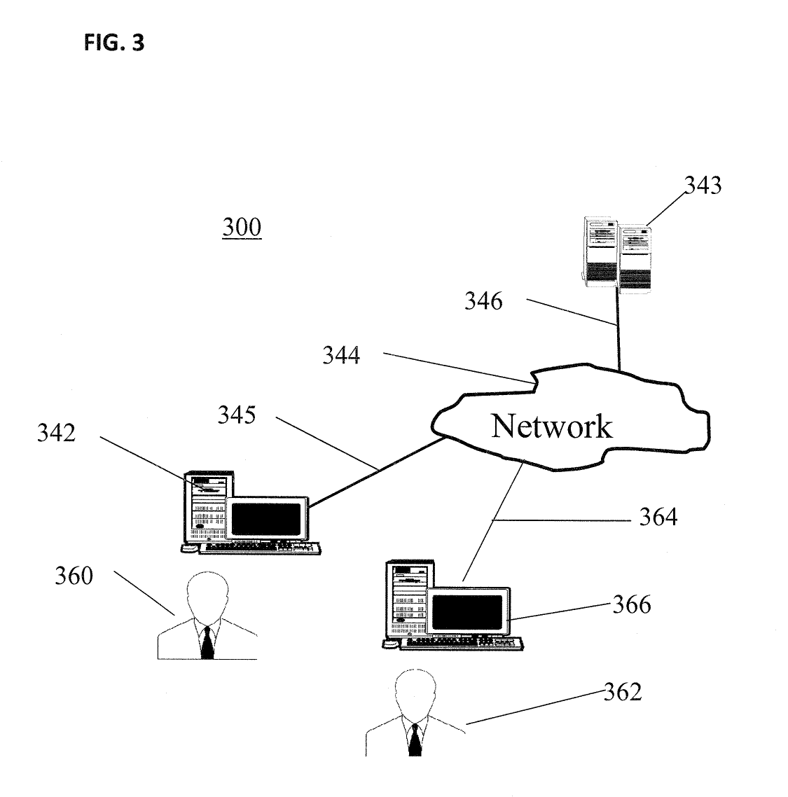

FIG. 3 is a block diagram of various example system components, in accordance with aspects of the present invention. FIG. 3 shows a communication system 300 usable in accordance with the aspects presented herein. The communication system 300 includes one or more accessors 360, 362 (also referred to interchangeably herein as one or more “users” or clients) and one or more terminals 342, 366. In an implementation, data for use in accordance with aspects of the present invention may be, for example, input and/or accessed by accessors 360, 364 via terminals 342, 366, such as personal computers (PCs), minicomputers, mainframe computers, microcomputers, telephonic devices, or wireless devices, such as personal digital assistants (“PDAs”) or a hand-held wireless devices coupled to a server 343, such as a PC, minicomputer, mainframe computer, microcomputer, or other device having a processor and a repository for data and/or connection to a repository for data, via, for example, a network 344, such as the Internet or an intranet, and couplings 345, 346, 364. The couplings 345, 346, 364 include, for example, wired, wireless, or fiberoptic links.

Discovering and analyzing a system's object model can be done statically (compile time) and/or dynamically (run-time). The static/compile time approach is the traditional approach used by compilers and static tool chains. It requires access to source code and/or static object model/schema definitions.

Current systems use static analysis of source code and/or static object model/schema definitions. When run-time information is used, it is generally used to determine object types. Instead of this previous approach, aspects presented herein dynamically create a rich meta object model and framework that is used to analyze dynamic systems in a generalized way. Very high performance is obtained via the extensive use of model and results caching. A dynamic run-time approach is a more advanced approach and requires support for run-time information, such as introspection/reflection, within the language run-time. Most modern languages support run-time type information. A static approach may be used when a run-time approach is not available.

Thus, analysis and traversal of object models for third party systems and source code can be made at run-time without the need for access to the original object model or source code. This allows cloud-based tools to be provided without direct access to the third party source code and without making any changes to the third party system. This is done by creating a canonical meta object model, from run-time and/or static type/schema information, which is then utilized at run-time. The meta object model enables the in-place object model analysis and traversal.

Aspects presented herein solve a large class of computing problems through object model analysis and traversal. For example, aspects can address deep copy, serialization, transactions, transactional memory, and in-process and distributed garbage collection.

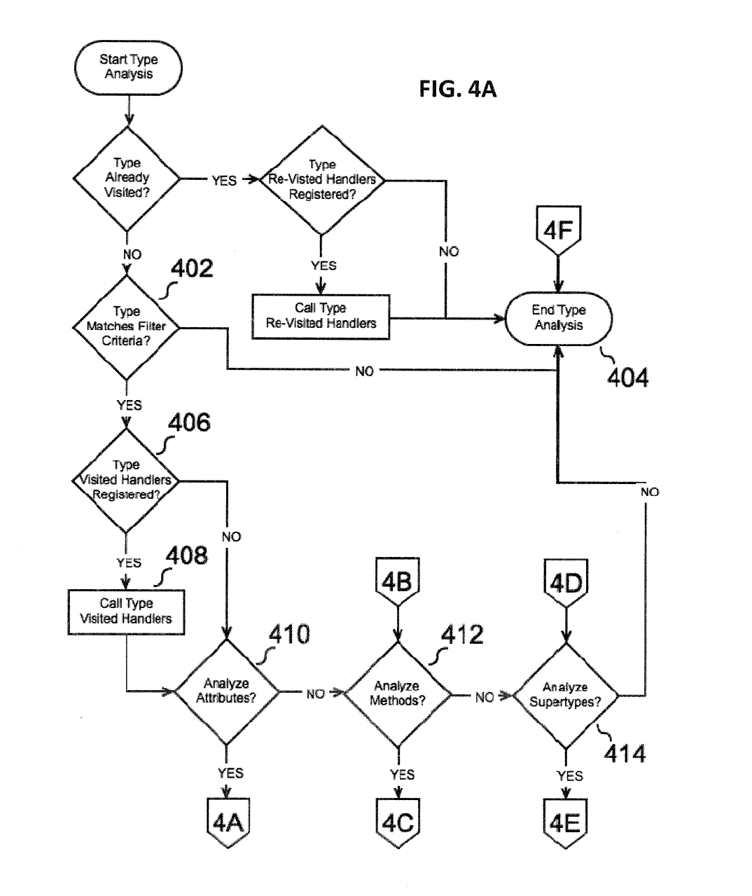

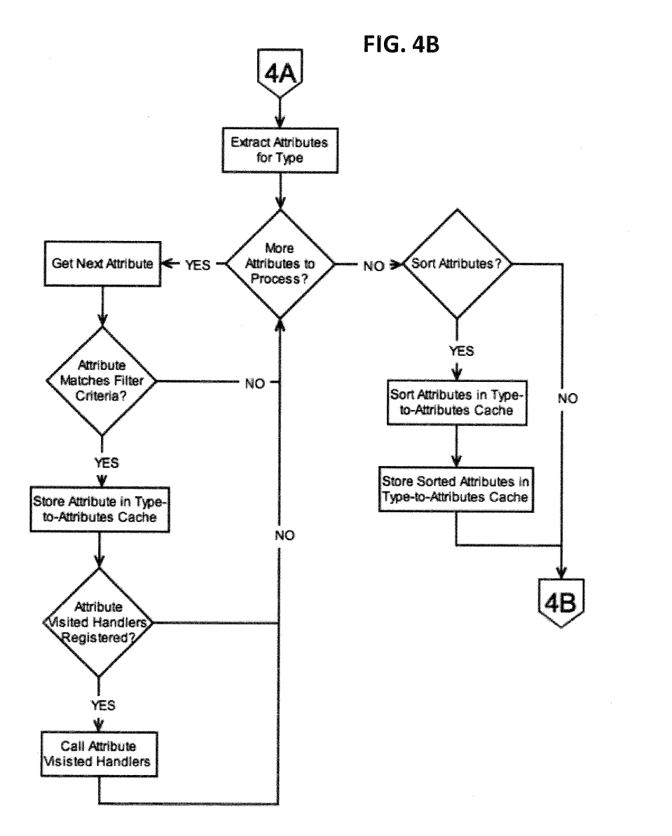

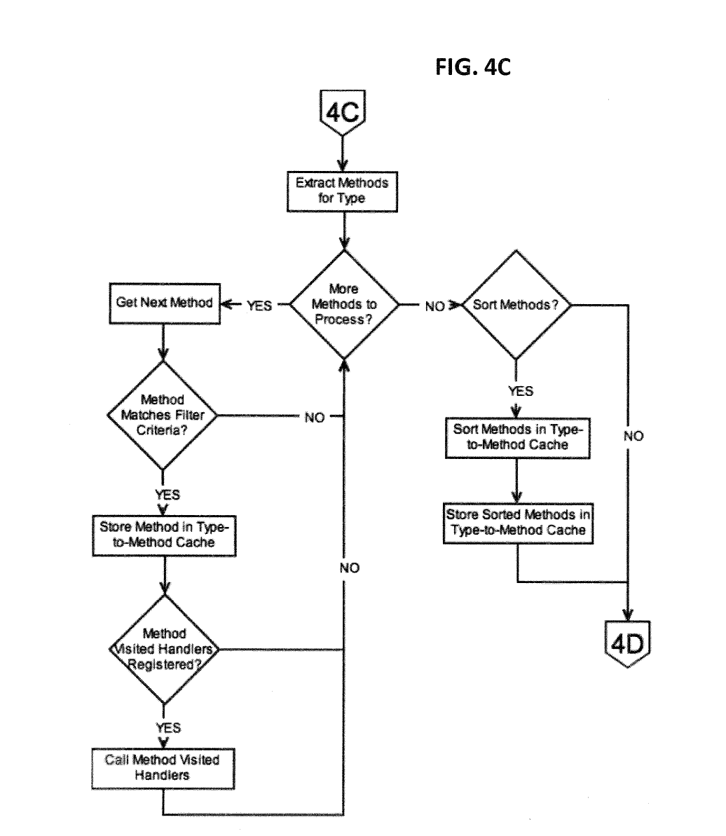

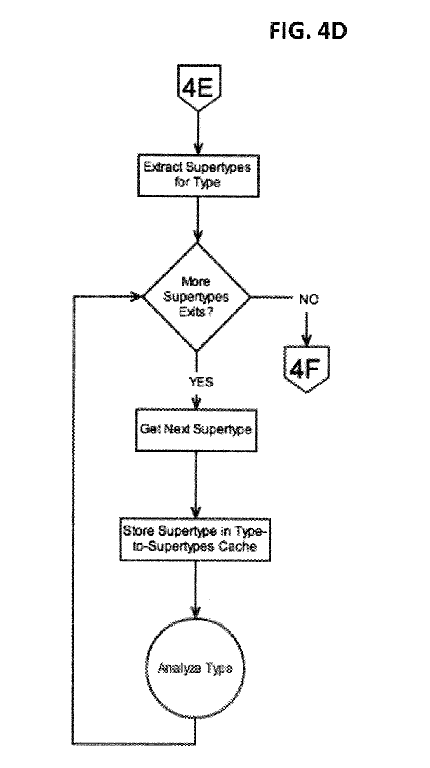

FIGS. 4A-4D present a flow chart illustrating an object model analysis in accordance with aspects of the present invention. This analysis can be used to build an optimized cache of schema information for the third party system. A re-usable meta schema is built based on an analyzed object model. The type hierarchy of various object models can be pre-computed to establish a chain of objects that will be needed in traversal.

Prior to the analysis in FIG. 4A, an object or a type is received at run-time from a third party system. Depending on the third party system, various terminologies may be used. For example, in JAVA, it is a class. At step 402, a determination is made as to whether the object or type matches filter criteria. Although the term “type” is used in the example illustrated in FIGS. 4A-4D, the analysis may also be performed for an object. At this step, the analysis determines whether the item is an object or type. For example, if the item is an integer, the filter criteria will not be matched, and the analysis will proceed to step 404 where it ends. If the item does match the filter criteria, at step 406, a determination is made as to whether the type has already been analyzed by determining whether it has been registered. If the type has been registered, at step 408, the visited handlers are accessed. If the type has not been previously registered, the analysis proceeds to steps 410, 412, and 414, where it is determined whether the attributes, methods, and/or supertype of the type should be analyzed. By analyzing these different aspects of the type or object, an arbitrary system/core algorithm can be created for the system to access and utilize. FIGS. 4A-4D illustrate that the attribute/method/supertype for the type are extracted. Then, it is determined whether there are additional attributes/methods/supertypes to be processed. Once each of the desired attributes/methods/supertypes has been extracted, they may be sorted and stored in a related cache.

For example, in FIG. 4B, once a determination is made to analyze attributes of the type at step 410 from FIG. 4A, attributes from the type are extracted. Attributes are extracted by various methods, including but not limited to, utilizing run-time type information and introspection in run-times which support those features.

As each attribute is extracted, a determination is made as to whether there are more attributes to process. If there are additional attributes to process, the attribute matches are filtered. If the attribute matches filter criteria, the attribute is stored in a type-to-attribute cache. Once stored in the cache, a determination is made as to whether the attribute has already been analyzed by determining whether it has been registered. If so, the handler for the attribute can be obtained and an indication is made that the handlers are being visited

Once all attributes have been processed, a determination is made whether to sort the attributes. Sort order is varied based on application requirements. If a sort order is specified the attributes in the type-to-attribute cache are sorted and the sorting is stored, otherwise the natural order is stored.

Thereafter, a determination is made whether to analyze methods for the type at 412 in FIG. 4A. As illustrated in FIG. 4C, methods for the type are extracted, processed, filtered, sorted, and stored, similar to the attributes for the type in FIG. 4B. At 4D, a determination is made whether to analyze supertypes for the type at 414. FIG. 4D illustrates that supertypes are extracted for the type. After each supertype is extracted, a determination is made as to whether additional supertypes exist for the type. Each supertype is stored in a type-to-supertype cache. Thereafter, the type is analyzed. When it is determined that no additional supertypes exist for the type, the type analysis ends at 404.

The analysis results allow the discovery of the type hierarchy, attributes, and methods. For each type analyzed, a child-to-parent and parent-to-child relationship can be discovered to provide the type hierarchy. The attributes can be discovered, and this information is combined with the discovered hierarchy relationships to provide all attributes for the type. The methods can also be discovered. This information is then combined with the hierarchy information to provide all the methods for a type.

The depth of the hierarchy, attributes, and methods can all be filtered to provide subsets or views of the object model. Multiple subsets can exist simultaneously. The discovered results can also be ordered to enforce desired ordering during object model traversal. In languages where the types do not change at run-time, the results from the analysis performed in FIG. 4 can be cached. This substantially increases performance. Each attribute, method, and type visited during the analysis process can be obtained through the use of analysis handlers. This allows external programs to “hook” or obtain results from the generalized analysis process.

Traversing the types in the type system requires accounting for previously visited types lest an infinite loop be created. Thus, each type discovered is checked to determine whether it has already been traversed. If it has been traversed, it is not traversed again, breaking the traversal cycle.

The analysis in FIGS. 4A-4D enables a model to be created without direct access to a third party's source code. Once the model is built, it can be used to accelerate the traversal of objects related to the third party system.

Thus, aspects include obtaining run-time information from a third party system, performing an analysis of a plurality of objects from the third party system, building a re-useable meta schema based on the analysis, caching the re-useable meta schema, and then applying run-time behaviors to the stored meta schema during traversal.

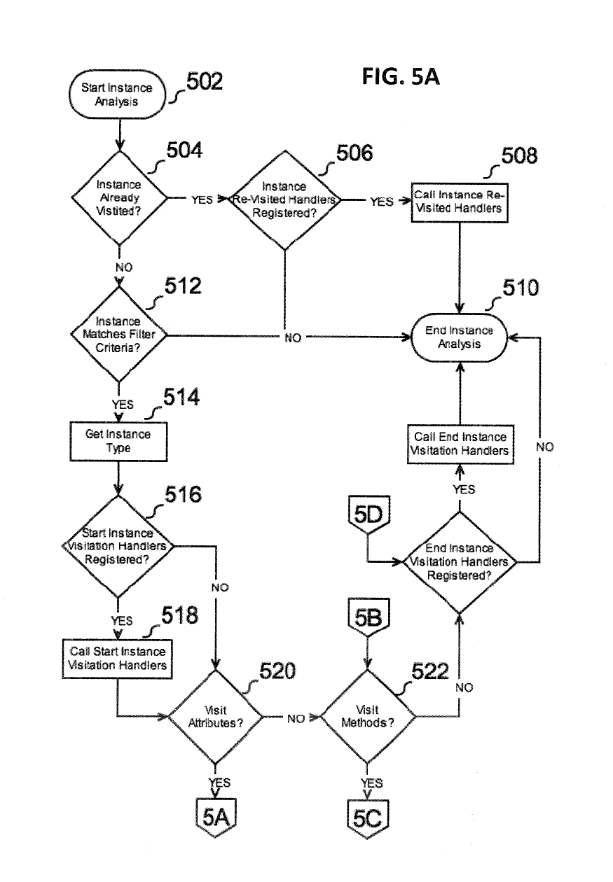

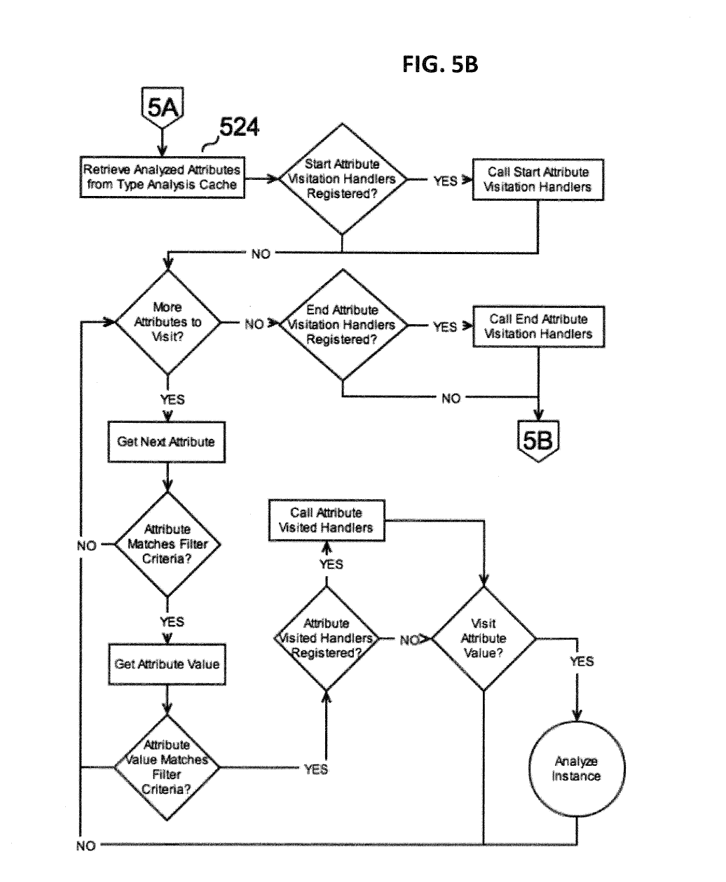

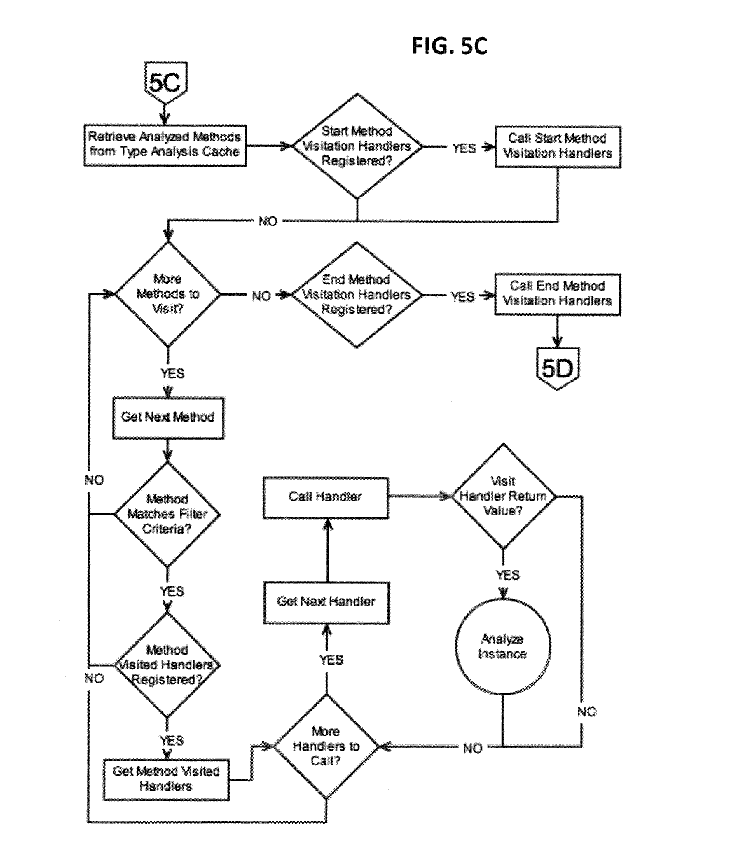

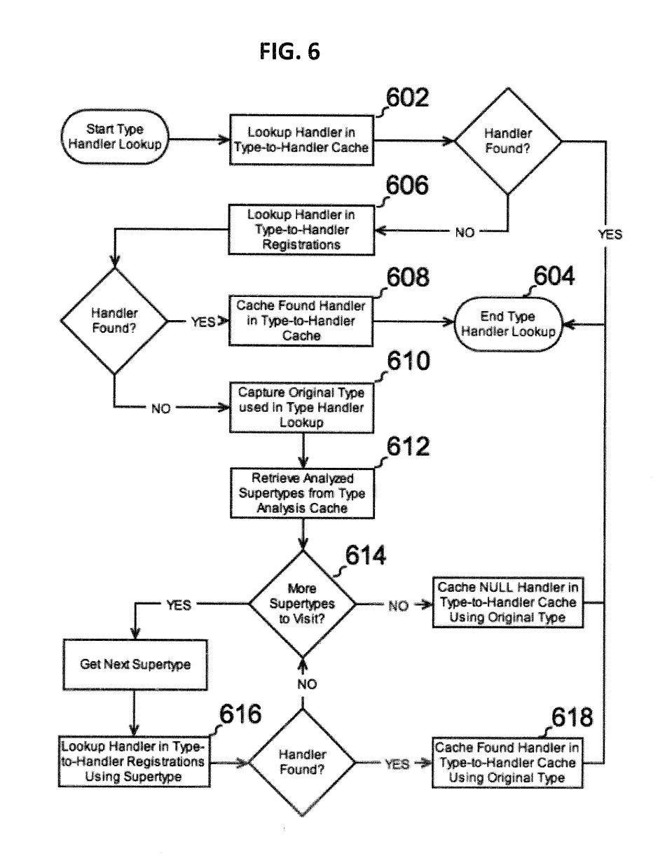

For example, if run-time object serialization behavior is desired the analysis in FIG. 4 plus the traversal and instance handling in FIG. 5 and the optimized type handling in FIG. 6 are combined to produce the desired run-time serialization behavior. Related aspects with regard to serialization are described in U.S. Provisional Application No. 61/429,964 entitled “Serialization System and Method” filed on Jan. 5, 2011, the entire contents of which are expressly incorporated by reference herein in their entirety.

FIGS. 5A-5C depict a flow chart illustrating example aspects of in-place traversal based on the in-place analysis. The flow chart in FIG. 5A begins with type or model attributes stored in memory. At step 502, an instance of a type or object is input. At 504, it is determined whether the instance has already been visited. If the instance has already been visited, it is determined whether instance re-visited handlers have been registered for the re-visited instance. If handlers have been registered, the handlers are obtained at 508 and an indication is made that the handlers are being visited and the analysis ends at 510. If a handler has not been registered, the analysis ends at 510.

If the instance has not been previously visited, it is determined whether the instance meets filter criteria at 512. If so, the run-time type information is imported at 514 and it is determined whether the handlers are registered for this instance at 516. If handlers are registered, an indication is made that the handlers are being visited at 518. At steps 520 and 522, it is determined whether the attributes and/or methods are to be visited. Once this determination is made, the previously analyzed attributes or methods are retrieved from the type analysis cache at 524 and 526. As FIGS. 5A-5C illustrate, multiple attributes and methods can be addressed for the instance. It is noted that both the attributes and methods can be visited for the instance. This can be important for certain applications, e.g. if serialization is to be performed for generated values.

FIG. 5B illustrates the visiting of attributes for the instance. At 524, the analyzed attributes for the type are retrieved from the previously stored type analysis cache. A determination is made as to whether start attribute visitation handlers have been registered for this instance. If so, the handlers are obtained and an indication is made that the handlers are being visited. Attributes for the type are then processed. A determination is made as to whether there are attributes for the type to visit. If so, the next attribute is obtained and filtered. If the next attribute matches filter criteria, the attribute's value is obtained and filtered. As used herein, attributes are cached schema elements that allow attribute values to be obtained. If the additional attribute value matches filter criteria, a determination is made as to whether attribute visited handlers are registered for the additional attribute. If handlers are registered for the attribute, the handlers are obtained and an indication is made that the handlers are being visited. In any case, a determination is made whether to visit the attribute value. If so, the instance is analyzed. This is a recursive analysis starting at 502 and assumes that a type analysis, as illustrated in FIG. 4 has been done for the type of the instance. Once each of the attributes for the type have been visited and any corresponding attribute handlers have been obtained, with a corresponding indication that the handlers have been visited, the process returns to 522 to determine whether to visit methods for the type. FIG. 5C illustrates that a similar process to FIG. 5B is followed for the type methods.

Thus, once an object model has been discovered, either statically or dynamically, the object instance's attributes and methods can be traversed at run-time. The entire object graph associated with an object instance can be traversed. Specifically, for an object, each of its attributes can be obtained, and if an attribute is itself an object or object reference, that object can in turn be traversed.

Traversing object instances requires accounting for previously visited instances lest an infinite loop be created. Thus, each object instance discovered is checked to see if it has already been traversed. If it has been traversed it is not traversed again, breaking the traversal cycle.

The above method provides a generalized mechanism for analyzing and then traversing any object model. In order for this general technique to be useful (e.g., implementing useful functions beyond object model discovery and run-time object traversal itself) a traversal handler interface/API is defined.

As objects and their attributes/methods are traversed the traversal handler interface/API can be called at well defined points in the traversal process.

FIG. 6 illustrates aspects of type handlers. When an object model is given and the source code cannot be changed, it is necessary to generalize the behavior to the standard way that it is within the source code/system. Typically, the system is accessed and modified by injecting code.

Aspects of FIG. 6 enable new behaviors or states to be attached to an existing hierarchical model and allows the behavior to follow the hierarchy model without access to the third party source code. This enables a number of parallel behaviors to follow the hierarchy model. First, a type is provided. At step 602, the type handler is looked up in a type-to-handler associate memory. This may be, for example, a hash table. If the handler is found, the information can be obtained and the process ends at 604. If the handler is not found, additional caches may be searched that identify manners in which types have been handled at 606. These may include various type-to-handler registrations. If a handler is found, it is cached in the type-to-handler cache at 608. If the handler is not found, the original type is captured using a query at 610. At 612, the analysis goes to the supertype for the type from a type analysis cache. This may involve determining a number of supertypes as at 614. Once the supertypes have been obtained, the type-to-handler registration is searched using the supertype information at 616. If the handler is found, it is added to the type-to-handler cache at 618. If it is not found, the process continues for any additional supertypes. Once all of the supertypes have been exhausted, the process ends if no handler has been found.

Operations on objects (e.g., during traversal) are often based on object type. When source code is available and can be modified these operations are generally implemented as methods. However, when source code is not available or when the source code cannot or should not be modified, another approach is needed. Type handlers are the generalized solution to this problem.

A type handler is an arbitrary association of type to object, where the object can be an abstract interface, callback, etc. When looking up a handler for a given type the type hierarchy is followed and the “best” match is found.

Each time a new registration or de-registration is performed, the cache can be cleared.

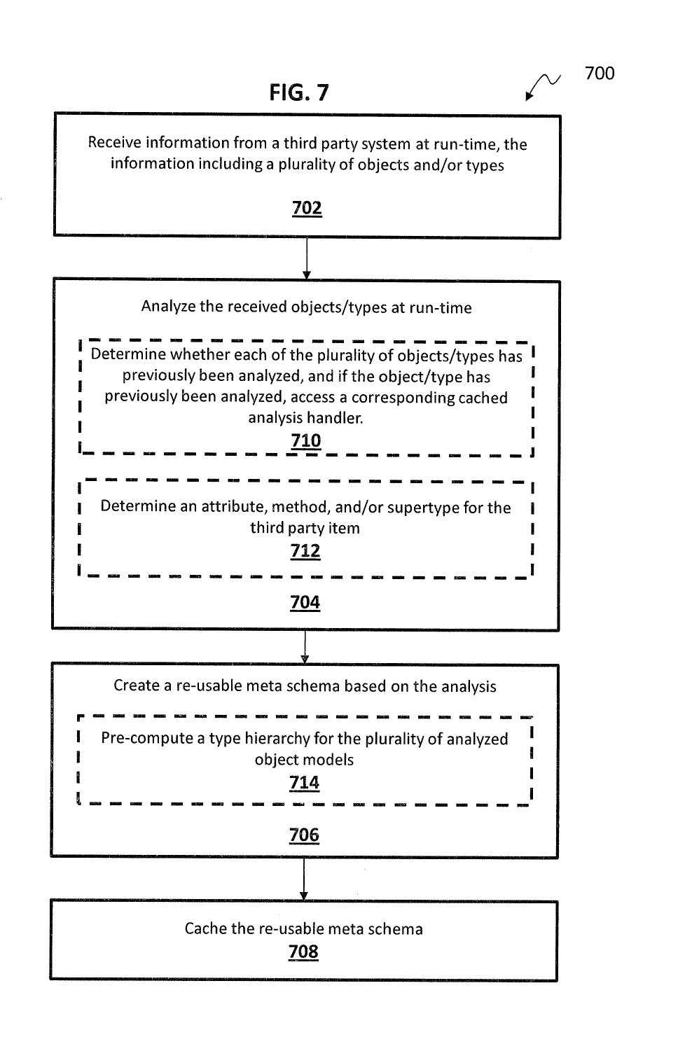

FIG. 7 illustrates an example flow chart for a method 700 of in-place object model analysis for a third party system having third party source code according to aspects presented herein. Optional aspects are illustrated having a dashed line.

At step 702, information is received from a third party system, the information including a plurality of objects and/or types items. The information may pertain to both run-time structure and/or compile time structure.

At step 704, the received objects/types are analyzed at run-time. This analysis can be performed without accessing the third party object model and/or the third party source code for the objects/types. This analysis may include a determination of whether each of the objects/types has previously been analyzed 710. If an object/type has previously been analyzed, the method may include accessing a cached analysis handler for the item. The analysis may further include determining attributes, methods, and/or supertypes for each object/type 712, as illustrated in more detail in FIGS. 4-6.

At step 706, a re-usable meta schema is created based on the analysis from 704. This may include, for example, pre-computing a type hierarchy for the plurality of analyzed object models.

At step 708, the re-usable meta-schema is cached.

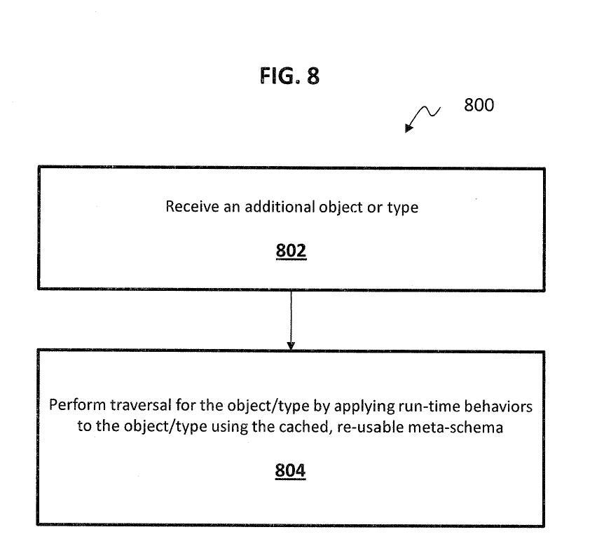

FIG. 8 illustrates additional aspects 800 that may be performed in connection with the method of FIG. 7. For example, at 802, an additional object/type may be received. Then, at 804, traversal may be performed for the additional object/type by applying run-time behaviors to the additional item using the cached, re-usable meta-schema from 708.

This traversal 804 may be performed without accessing the third party object model/source code for the additional object/type.

Aspects of the methods described in FIGS. 7 and 8 can be applied in a cloud-based environment, similar to the environment illustrated in FIG. 1. For example, the third party information may be received via the cloud 102. In addition, aspects of the analysis in step 704 and the traversal in step 804 may be performed in the cloud 102. Further, the re-usable meta-scheme may be cached in a storage medium within the cloud 102.

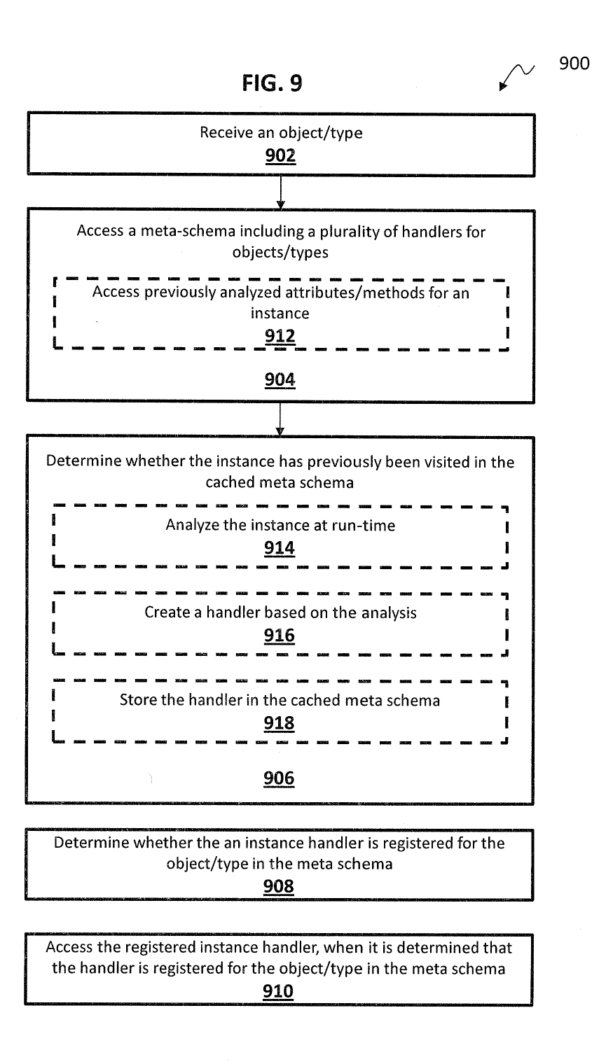

FIG. 9 illustrates a flow chart for a method for in-place object model traversal, according to aspects of the present invention. At 902, an object/type is received. At 904, a cached meta schema is accessed. The meta schema includes a plurality of handlers for objects and types. At 906, a determination is made as to whether the instance has previously been visited in the cached meta schema. At 908, a determination is made as to whether an instance handler is registered for the item in the cached meta schema. At 910, the registered instance handler is accessed, when it is determined that the handler is registered for the instance in the cached meta schema.

If the instance has not previously been visited, the method may further include analyzing the instance at run-time 914, creating a handler based on the analysis 916, and storing the handler in the cached meta schema 918.

This may include accessing at least one of a plurality of previously analyzed attributes and a plurality of previously analyzed methods for the instance 912, wherein the previously analyzed attributes and methods are stored in the cached meta schema.

Aspects of the method illustrated in FIG. 9 may be performed in a cloud-based environment. For example, the meta schema may be cached in the cloud-based environment similar to 102 in FIG. 1. Further, the determinations in steps 904 and 906 may be facilitated via a cloud similar to 102 in FIG. 1. The analysis may be performed without accessing the third party object model and/or source code for the object/type.

Aspects of the present invention may further include an automated system for object model analysis including means for receiving objects/types from a third party system; means for analyzing, via a processing device, the received, third party objects/types at run-time; means for creating a re-usable meta schema based on the analysis; and means for caching the re-usable meta-schema. The means may include, for example, components illustrated in FIGS. 1-3.

Aspects may further include an automated system for object model analysis. The system may include at least one processor, a user interface functioning via the at least one processor, and a repository accessible by the at least one processor. The processor may be configured to receive objects/types from a third party system at run-time; analyze, via a processing device, the received objects/types at run-time; create a re-usable meta schema based on the analysis; and cache the re-usable meta-schema.

Aspects may further include a computer program product comprising a non-transitory computer readable medium having control logic stored therein for causing a computer to perform object model analysis, the control logic code for: receiving objects/types from a third party system; analyzing, via a processing device, the received objects/types at run-time; creating a re-usable meta schema based on the analysis; and caching the re-usable meta-schema.

Aspects may further include an automated system for in-place object model analysis. The system may include means for receiving a third party object/type item; means for accessing a cached meta schema, the meta schema comprising a plurality of handlers for objects and types; means for determining, via a processing device, whether the instance has previously been visited in the cached meta schema; means for determining whether an instance handler is registered for the item in the cached meta schema; and means for accessing the registered instance handler, after it is determined that the handler is registered for the item in the cached meta schema.

Aspects may further include an automated system for in-place object model analysis. The system may include at least one processor, a user interface functioning via the at least one processor, and a repository accessible by the at least one processor. The processor may be configured to receive a third party object/type item; access a cached meta schema, the meta schema comprising a plurality of handlers for objects and types; determine, via a processing device, whether the instance has previously been visited in the cached meta schema; determine whether an instance handler is registered for the item in the cached meta schema; and access the registered instance handler, after it is determined that the handler is registered for the item in the cached meta schema.

Aspects may further include a computer program product comprising a non-transitory computer readable medium having control logic stored therein for causing a computer to perform object model analysis, the control logic code for: receiving a third party object/type item; accessing a cached meta schema, the meta schema comprising a plurality of handlers for objects and types; determining, via a processing device, whether the instance has previously been visited in the cached meta schema; determining whether an instance handler is registered for the item in the cached meta schema; and accessing the registered instance handler, after it is determined that the handler is registered for the item in the cached meta schema.

While this invention has been described in conjunction with the example aspects of implementations outlined above, various alternatives, modifications, variations, improvements, and/or substantial equivalents, whether known or that are or may be presently unforeseen, may become apparent to those having at least ordinary skill in the art. Accordingly, the example illustrations, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed is:

1. An automated method of in-place object model analysis for a third party system having third party source code, the method comprising:
receiving information from a third party system, the information including a plurality of items, each item comprising at least one selected from a group consisting of an object and a type;
via a processing device, analyzing the received third party items at run-time;
creating a re-usable meta schema based on the analysis; and
caching the re-usable meta-schema.

2. The method of claim 1, wherein the analysis of the plurality of third party items is performed without accessing the third party object model and the third party source code for the plurality of third party items.

3. The method of claim 2, wherein analyzing the received third party items at run-time comprises:
determining whether each of the plurality of third party items has previously been analyzed, and
if the item has previously been analyzed, accessing a cached analysis handler for the item.

4. The method of claim 3, wherein analyzing the received third party items at run-time comprises:
determining at least one selected from a group consisting of an attribute, a method, and a supertype for the third party item.

5. The method of claim 4, further comprising:
pre-computing a type hierarchy for the plurality of analyzed object models.

6. The method of claim 5, further comprising:
receiving an additional third party item, the additional third party item comprising at least one selected from a group consisting of an additional object and an additional type; and
performing traversal for the additional third party item by applying run-time behaviors to the additional third party item using the cached, re-usable meta-schema,
wherein the traversal is performed without accessing the third party object model and the third party source code for the additional third party item.

7. The method of claim 1, wherein analyzing the received third party items at run-time is performed in a cloud-based environment, and wherein caching the re-usable meta schema occurs in the cloud-based environment.

8. An automated method of in-place object model traversal, the method comprising:
receiving an item, the item comprising an instance of at least one of an object and a type;
accessing a cached meta schema, the meta schema comprising a plurality of handlers for objects and types;
determining, via a processing device, whether the instance has previously been visited in the cached meta schema;
determining whether an instance handler is registered for the item in the cached meta schema; and
accessing the registered instance handler, after it is determined that the handler is registered for the item in the cached meta schema.

9. The method of claim 8, wherein, if the instance is determined not to previously have been visited, the method further comprising:
analyzing the instance at run-time;
creating a handler based on the analysis; and
storing the handler in the cached meta schema.

10. The method of claim 8, further comprising:
accessing at least one of a plurality of previously analyzed attributes and a plurality of previously analyzed methods for the instance, wherein the previously analyzed attributes and methods are stored in the cached meta schema.

11. The method of claim 8, wherein analyzing the instance at run-time is performed in a cloud-based environment, and wherein the re-usable meta schema is cached in the cloud-based environment, and wherein analyzing the instance at run-time is performed without accessing the third party object model and the third party source code for the third party item.

12. An automated system for object model analysis, the system comprising:
means for receiving information from a third party system, the information including a plurality of items, each item comprising at least one selected from a group consisting of an object and a type;
means for analyzing, via a processing device, the received third party items at run-time;
means for creating a re-usable meta schema based on the analysis; and
means for caching the re-usable meta-schema.

13. The system of claim 12, wherein the means for analyzing is configured to analyze the plurality of third party items without accessing the third party object model and the third party source code for the third party item.

14. The system of claim 13, wherein the means for receiving is configured to receive an additional third party item, the additional third party item comprising at least one selected from a group consisting of an additional object and an additional type, the system further comprising:
means for performing traversal for the additional third party item by applying run-time behaviors to the additional third party item using the cached, re-usable meta-schema,
wherein the traversal is performed without accessing the third party object model and the third party source code for the additional third party item.

15. An automated system for object model analysis, the system comprising:
at least one processor;
a user interface functioning via the at least one processor; and
a repository accessible by the at least one processor; wherein the at least one processor is configured to:
receive information from a third party system, the information including a plurality of items, each item comprising at least one selected from a group consisting of an object and a type;
analyze, via a processing device, the received third party items at run-time;
create a re-usable meta schema based on the analysis; and
cache the re-usable meta-schema.

16. The system of claim 15, wherein the at least one processor is in a cloud-based environment, and wherein the analysis for the plurality of third party items is performed without accessing the third party object model and the third party source code for the third party item.

17. The system of claim 16, wherein the at least one processor is further configured to:
receive an additional item, the additional third party item comprising at least one selected from a group consisting of an additional object and an additional type; and
perform traversal for the additional item by applying run-time behaviors to the additional item using the cached, re-usable meta-schema,
wherein the traversal is performed without accessing the third party object model and the third party source code for the additional item.

18. A computer program product comprising a computer readable medium having control logic stored therein for causing a computer to perform object model analysis, the control logic code for:
receiving information from a third party system, the information including a plurality of items, each item comprising at least one selected from a group consisting of an object and a type;
analyzing, via a processing device, the received third party items at run-time;
creating a re-usable meta schema based on the analysis; and
caching the re-usable meta-schema.

19. The computer program product according to claim 18, wherein the analysis for the plurality of third party items is performed without accessing the third party object model and the third party source code for the third party item.

20. The computer program product according to claim 19, further comprising control logic code for:
receiving an additional third party item, the additional third party item comprising at least one selected from a group consisting of an additional object and an additional type; and
performing traversal for the additional third party item by applying run-time behaviors to the additional third party item using the cached, re-usable meta-schema,
wherein the traversal is performed without accessing the third party object model and the third party source code for the additional third party item.
